(19) United States
(12) Patent Application Publication
(10) Pub. No.: US 2018/0374457 A1
(43) Pub. Date: Dec. 27, 2018

(54) CURVED, ERGONOMIC PLECTRUM FOR A STRINGED INSTRUMENT

(71) Applicant: Tao Bernardi, Dublin, CA (US)

(72) Inventor: Tao Bernardi, Dublin, CA (US)

(21) Appl. No.: 16/013,920

(22) Filed: Jun. 20, 2018

Related U.S. Application Data
(60) Provisional application No. 62/523,068, filed on Jun. 21, 2017.

(51) Int. Cl. G10D 3/16

(52) U.S. Cl. CPC G10D 3/163

(57) ABSTRACT

An ergonomic plectrum which includes a curve, or pitch, along the plectrum's transverse axis. The amount of curvature is reflected as the ratio of the height of the curve, or pitch, to the length of the rear width. The amount of curvature can also be reflected as the radius of curvature. This curvature, or pitch, of the plectrum increases surface area contact with the user's digits while allowing the user to select a multitude of grips. The preferred embodiment of the ergonomic plectrum resembles a curved, teardrop shaped plectrum.

### CROSS-REFERENCE TO RELATED APPLICATIONS

This application claims priority to U.S. Provisional Patent Application No. 62/523,068, “Curved, Ergonomic Stringed-Instrument Pick,” filed on Jun. 21, 2017. This application is incorporated by reference herein in its entirety.

### FIELD OF THE INVENTION

The disclosed embodiments relate generally to stringed instrument plectra, and more specifically to guitar and bass plectra.

### BACKGROUND OF THE RELATED ART

When playing a stringed instrument, the user will typically employ a plectrum, or pick, to strike the strings. Striking the string with a plectrum produces subtle differences in the sound emitted by the instrument. Traditionally, the plectrum is grasped by the user with two digits; the thumb in combination with another digit. This traditional grip places a large amount of stress upon the user's fingers and wrist, resulting in fatigue and injury. Additionally, the limited surface area contact between a planar plectrum and the user's digits results in the plectrum turning or slipping during use.

Many attempts have been made to produce a plectrum which limits fatigue and increases stability. The first example of a common strategy to limit fatigue and increase stability is to accommodate the thumb and another digit in depressions in the top and bottom surface of the plectrum. These indentations allow for a more ergonomic and less fatiguing grip, but only with two fingers. Moreover, surface area contact with the user's digits is limited thereby limiting stability of the plectrum.

Another example of an ergonomic plectrum is one that utilizes recesses for three fingertips, two on the top surface and one on the bottom surface. These three indentations permit the user to grasp the pick with two or three fingers. Again, however, this style of plectrum does not maximize surface area contact with the user's digits, which results in slipping and turning during play. Furthermore, the recesses require the user grasp the plectrum with their fingertips, resulting in a tense and strained grip.

A final example of a plectrum designed to limit slipping are plectrums which incorporate a ridge on their surface. The ridge is designed to rest against the user's digits, providing rotational resistance and increased surface area, thereby limiting rotation and improving the stability of the plectrum.

The above three examples fail to provide a comfortable user experience and to maximize surface area contact between the user's digits and the plectrum. This leads to an uncomfortable plectrum which permits few gripping options and is prone to slipping and turning. What is needed is a plectrum which increases comfort by permitting multiple gripping options and maximizes surface area contact with the user's digits to limit slipping and turning.

### SUMMARY OF THE INVENTION

The present invention is directed to an ergonomic plectrum for a stringed instrument. The ergonomic plectrum comprises a non-planar body consisting of a top surface, bottom surface, rear width, and two side portions. Opposite the non-planar body's rear width is a string engaging width. The string engaging width can be planar or non-planar, depending on the user's preference.

The two side portions of the ergonomic plectrum are bisected by a longitudinal axis. The plectrum is curved along this longitudinal axis, with both sides being curved in the same direction, forming a “C” shape. Preferably, the radius of curvature of the ergonomic plectrum is between 5 and 125 millimeters. Alternatively, the curvature of the ergonomic plectrum may be reflected as a ratio of the ergonomic plectrum's pitch to its rear width. In the preferred embodiment, the pitch of the ergonomic plectrum is 2 millimeters and the rear width is 25 millimeters, for a ratio of 0.08. This curvature results in a plectrum wherein no portion of the ergonomic plectrum's body resides in the same plane.

The ergonomic plectrum's curvature maximizes surface area contact with the user's digits and permits the user to select a multitude of digit arrangements. For example, the user may switch between a three-finger grip during a vigorous strumming section to a two-finger grip for hitting individual notes during a lead. Also, the curved nature of the ergonomic plectrum prevents the plectrum from digging into the user's digits by directing the plectrum's edges away from the user's digits. The current invention therefore solves the aforementioned problems and creates a comfortable, stable ergonomic plectrum.

### BRIEF DESCRIPTION OF THE DRAWINGS

FIG. 1 is a top view of the related “Piglet” plectrum.

FIG. 2 is a bottom view of the related “Piglet” plectrum.

FIG. 3 is a top view of the related “Big Stubby” plectrum.

FIG. 4 is a bottom view of the related “Big Stubby” plectrum.

FIG. 5 is a top view of an embodiment of the current invention.

FIG. 6 is a bottom view of an embodiment of the current invention.

FIG. 7 is a front sectional view along line 7-7 in FIG. 6 of an embodiment of the current invention illustrating the radius of curvature.

FIG. 8 is a top view of an embodiment of the current invention showing the relative dimensions of the current invention.

### DESCRIPTION OF THE PREFERRED EMBODIMENTS

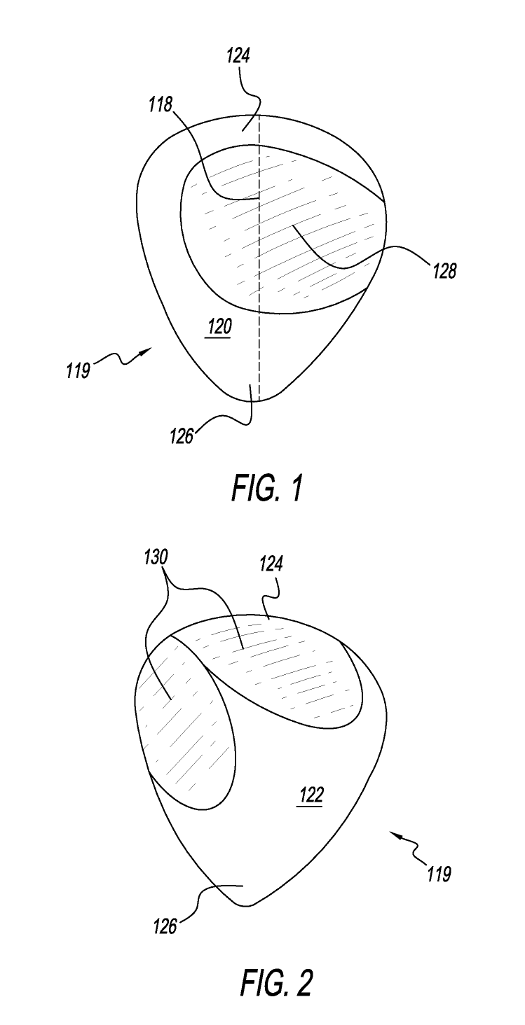

FIGS. 1-2 show the related “Piglet” 119 plectrum. The Piglet 119 is substantially teardrop-shaped, having a string engaging portion 126 opposite a rear portion 124. The Piglet 119 comprises two surfaces, a top surface 120 and a bottom surface 122. Within the top surface 120 is a top surface receptacle 128 dimensioned to accommodate one digit. Within the bottom surface 122 is a bottom surface receptacle 130 dimensioned to accommodate one or two digits. In the current embodiment, the Piglet's 119 top surface receptacle 128 is grasped with the thumb and the bottom surface receptacles 130 are grasped with the index and middle fingers. Enhanced grip is solely accomplished by the top surface receptacle 128 and the bottom surface receptacle 130 closely conforming to the user's digits.

The Piglet 119 is planar, with no curvature along the longitudinal axis 118. Neither the top surface receptacle 128 nor the bottom surface receptacle 130 reside closer to the string engaging portion 126 than three-tenths of the length of the Piglet 119. Therefore, the closest the user may grasp the Piglet 119 to the string engaging portion 126 is approximately thirty percent of the length of the Piglet 119. Furthermore, the location and spacing of the bottom surface receptacle 130 prevent the user from adopting a wider or narrower grip—the user's digits must be placed within the bottom surface receptacle 130.

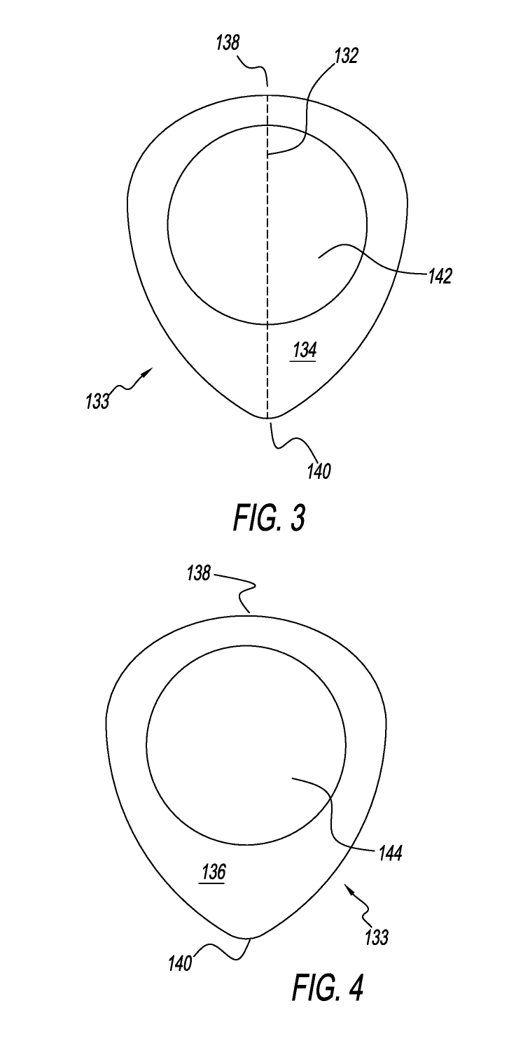

FIGS. 3-4 show the “Big Stubby” plectrum. The Big Stubby 133 is a substantially teardrop-shaped plectrum having a rear portion 138 and a string engaging portion 140. The Big Stubby 133 plectrum consists of a top surface 134 and a bottom surface 136. Within the top surface 134 is the top surface depression 142, and within the bottom surface 136 is the bottom surface depression 144. Both the top surface depression 142 and the bottom surface depression 144 are dimensioned to accommodate one digit. Also, the top surface depression 142 and the bottom surface depression 144 share the same center and diameter, the center being located on the longitudinal axis 132, approximately 18 millimeters from the string engaging portion 140.

The Big Stubby 133 plectrum is planar, having no curvature along the longitudinal axis 132. Enhanced grip is accomplished by placing one digit into each of the top surface depression 142 and the bottom surface depression 144. The user's digits may not be placed outside the top surface depression 142 or the bottom surface depression 144 should a wider grip be desired.

The lack of adjustability in gripping the Big Stubby 133 and Piglet 119 plectrums leads to a less comfortable and adaptable plectrum. Gripping either of these plectrums increases strain in the wrists, hands, and digits of the user. Limiting the user to one or two grip permutations prevents the user from using a comfortable, personalized grip. Additionally, users with smaller digits cannot employ a four-or-five-digit grip given the spacing and location of the depressions or receptacles. Further compounding the problem with these related plectra is the lack of curvature. This lack of curvature limits surface area contact, thereby limiting stability.

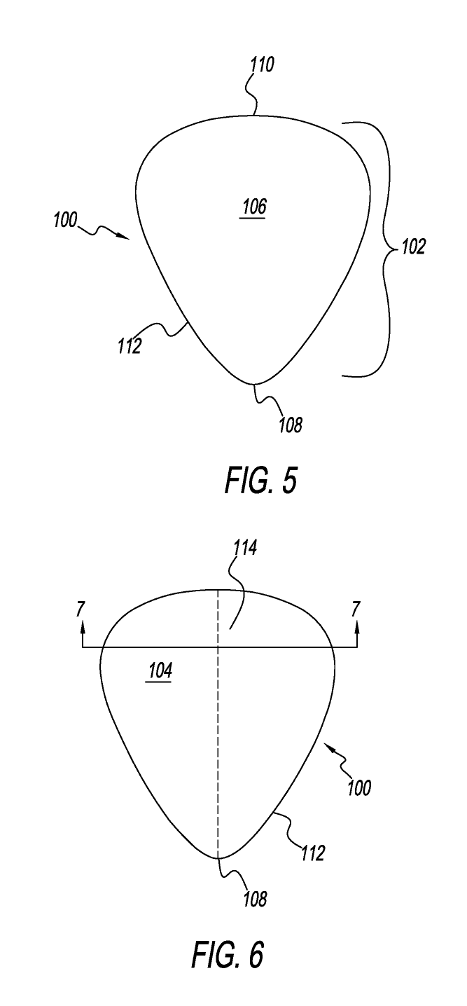

FIGS. 5-6 show the top surface 106 and bottom surface 104 view of the ergonomic plectrum 100. In the preferred embodiment of the ergonomic plectrum 100, the non-planar body 102 is substantially teardrop-shaped. In other embodiments, the non-planar body 102 consists of a rectangular, square, triangular, circular, or other shape. The ergonomic plectrum 100 consists of a string engaging width 108 opposite a rear width 110. Between the string engaging width 108 and the rear width 110 is at least one side portion 112. In the preferred embodiment there are two side portions 112 interposed between the rear width 110 and the string engaging width 108.

FIG. 6 shows the bottom surface 104 of the ergonomic plectrum 100. The ergonomic plectrum 100 is curved along the longitudinal axis 114. In the preferred embodiment, the longitudinal axis 114 bisects the side portions 112, creating two equal side portions 112 which are curved along this bisecting longitudinal axis 114 and have the same direction of curvature. Curvature of the ergonomic plectrum 100 occurs solely along this longitudinal axis 114, i.e. the ergonomic plectrum 100 is not S-shaped.

The contour of the ergonomic plectrum 100 also self-centers the ergonomic plectrum 100 on the user's digits. The self-centering of the ergonomic plectrum 100 in the user's digits positions the user's digits at the longitudinal axis 114 of the ergonomic plectrum 100 and helps limit sliding or shifting of the ergonomic plectrum 100 during play, by positioning the side portions 112 on either side of the user's digits. This maximizes surface area contact with the user's digits and the ergonomic plectrum 100 thereby maximizing stability.

The self-centering feature of the ergonomic plectrum 100, does not, however prevent the user from moving the ergonomic plectrum 100 forwards or backwards along the longitudinal axis 114. This permits the user to “choke up” on the ergonomic plectrum 100, i.e. holding the plectrum nearer to, or farther from, the string engaging width 108. Choking-up allows the user to quickly and easily alter their playstyle. For example, the user may wish to change the tonal qualities of the ergonomic plectrum 100 from a flat angle and sharper sound during the rhythm section, to a sharper angle and fuller sound during a solo section.

In the preferred embodiment, the string engaging width 108 may be planar, depending on the preference of the player. A planar string engaging width 108 leads to predictable interaction with the strings of the stringed instrument, creating a consistent sound.

In the preferred embodiment, the top surface 106 or the bottom surface 104, or both, may incorporate a gripping means. The gripping means may consist of surface indentations or protrusions on the bottom surface 104 or the top surface 106 of the ergonomic plectrum 100. The gripping means increases the stability of the ergonomic plectrum 100 in the user's digits by increasing friction between the player's digits and the ergonomic plectrum's 100 non-planar body 102. The gripping means also reduces fatigue by limiting the amount of force the user must place upon the ergonomic plectrum 100. Lower holding force reduces tension in the user's hand, thereby increasing comfort.

In the preferred embodiment, the ergonomic plectrum 100 is comprised of a rigid material capable of engaging the strings of a stringed instrument. Materials suitable for the task include, but are not limited to, inorganic or organic polymers, glasses, solid aggregates, ferrous metals, non-ferrous metals, or bone. The thickness of the material alters the sound the instrument produces, with thicker plectrums producing a fuller sound. In the preferred embodiment, the ergonomic plectrum 100 is available in varying thicknesses to satisfy the demands of different play styles and types of music.

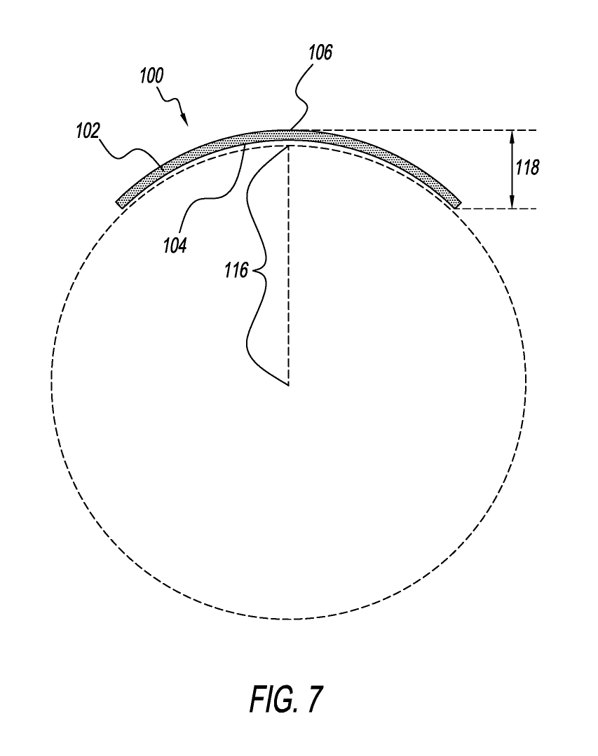

FIG. 7 shows the radius of curvature 116 of the ergonomic plectrum 100. Radius of curvature 116 is defined as the radius of a circle that touches a curve at a given point and has the same tangent and curvature at that point. The radius of curvature 116 of the ergonomic plectrum's 100 non-planar body 102 is between 5 millimeters and 125 millimeters. In the preferred embodiment, the radius of curvature 116 of the non-planar body 102 is 89 millimeters.

The radius of curvature 116 of the ergonomic plectrum 100 creates a non-planar ergonomic plectrum 100 that closely conforms to the user's digits. Close conformation greatly improves surface area contact between the ergonomic plectrum 100 and the user's digits and provides more gripping options to the user. The ergonomic plectrum 100 does not employ depressions or finger receptacles to enhance grip, permitting the user to employ a multi-finger grip. The close conformation of the ergonomic plectrum 100 and the lack of depressions or receptacles results in a more comfortable grip for the user and better tactile feedback.

The ability of a user of the ergonomic plectrum 100 to utilize multiple grips benefits novice and experienced users because of the ease of adjusting the user's grip. For example, a novice user may employ a three-finger grip, which is not locked into a depression or receptacle like other plectrums. Not locking the digits into a depression or receptacle makes the novice user's grip easily adjustable, allowing them to shift their digit placement to discover the most comfortable grip. Advanced users may wish to adopt different grips to suit different playstyles. For example, an advanced user may wish to have a more secure, but less maneuverable, grip during a vigorous strumming section, and a less secure, but more maneuverable, grip during a lead section. The current invention easily accommodates such an adjustment.

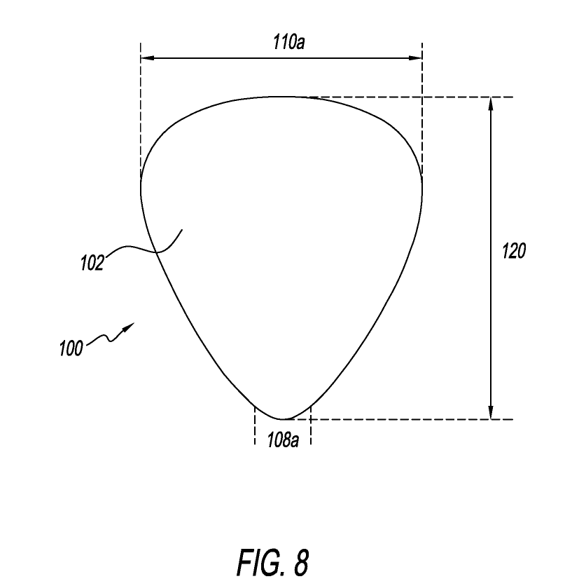

FIGS. 7-8 show another means for determining the curvature of the ergonomic plectrum 100; the pitch 118. Shown in FIGS. 7-8 are the relative dimensions of the ergonomic plectrum 100. FIG. 7 shows the pitch 118 of the ergonomic plectrum 100. FIG. 8 is a top view of the plectrum showing the dimensions of the rear width 110a, string engaging width 108a, and plectrum height 120. In the preferred embodiment of the ergonomic plectrum 100, the non-planar body 102 has a pitch 118 of 2 millimeters and a rear width 110a of 25 millimeters. The ratio of the pitch 118 to the rear width 110a in the preferred embodiment is 0.08. In another embodiment, the ergonomic plectrum's 100 pitch 118 is increased to 8 millimeters with a rear width 110a of 25 millimeters, for a ratio of pitch 118 to rear width 110a of 0.32. Larger or smaller pitch 118 heights may be utilized depending on the user's digit size.

Although several embodiments have been described for illustrative purposes, various modifications to the above-mentioned embodiments may be made without departing from the scope of the current invention. Thus, the scope is not limited except as by the appended claims.

I claim:

1. A plectrum for a stringed instrument comprising:
a non-planar body having a pitch, a top surface, a bottom surface, a rear width, and a string engaging width, wherein the pitch of the non-planar body is at least 0.08 times the length of the rear width.

2. The invention of claim 1, wherein the pitch of the non-planar body is less than or equal to 0.32 times the length of the rear width.

3. The invention of claim 1, wherein the non-planar body further comprises a high friction texture.

4. The invention of claim 1 wherein the plectrum further comprises a teardrop shape.

5. The invention of claim 1, wherein the plectrum further comprises a material consisting of an inorganic or organic polymer, glass, solid aggregate, ferrous or non-ferrous metal, or bone.

6. The invention of claim 1, wherein the string engaging width is planar.

7. A plectrum for a stringed instrument comprising:
A non-planar body having a pitch, a top surface, a bottom surface, a rear width, and at least one string engaging width, wherein the pitch has a radius of curvature of at least 15 millimeters.

8. The invention of claim 7, wherein the radius of curvature of the pitch is less than or equal to 125 millimeters.

9. The invention of claim 8, wherein the pitch has an identical radius of curvature throughout the non-planar body.

10. The invention of claim 7, wherein the non-planar body further comprises a high friction texture.

11. The invention of claim 7 wherein the plectrum further comprises a teardrop shape.

12. The invention of claim 7, wherein the plectrum further comprises a material consisting of inorganic or organic polymer, glass, solid aggregate, ferrous or non-ferrous metal, or bone.

13. The invention of claim 7, wherein the string engaging width is planar.

14. A plectrum for a stringed instrument comprising:
A non-planar body having a pitch, a top surface, a bottom surface, a rear width, at least one side portion, and at least one string engaging width positioned opposite the rear width wherein the pitch has a radius of curvature of at least 50 millimeters.

15. The invention of claim 14, wherein the radius of curvature is less than or equal to 110 millimeters.

16. The invention of claim 15, wherein the pitch has an identical radius of curvature throughout the non-planar body.

17. The invention of claim 14, wherein the non-planar body further comprises a high friction texture.

18. The invention of claim 14, wherein the plectrum further comprises a teardrop shape.

19. The invention of claim 14, wherein the plectrum material further comprises a material consisting of an inorganic or organic polymer, glass, solid aggregate, ferrous or non-ferrous metal, or bone.

20. The invention of claim 14, wherein the string engaging width is planar.
